(19) United States
(12) Patent Application Publication
(10) Pub. No.: US 2016/0225323 A1
(43) Pub. Date: Aug. 4, 2016

(54) Display Device and Method of Adjusting Backlight Brightness of Display Device

(71) Applicants: BOE Technology Group Co., Ltd., Beijing (CN); Beijing BOE Optoelectronics Technology Co., Ltd., Beijing (CN)

(72) Inventors: Pengcheng Lu, Beijing (CN); Zhongjun Chen, Beijing (CN); Xue Dong, Beijing (CN); Renwei Guo, Beijing (CN); Peng Liu, Beijing (CN); Mubing Li, Beijing (CN); Jinghua Miao, Beijing (CN)

(21) Appl. No.: 14/743,490

(22) Filed: Jun. 18, 2015

(30) Foreign Application Priority Data
Feb. 4, 2015 (CN) 201510059648.0

(51) Int. Cl. G09G 3/34

(52) U.S. Cl. CPC G09G 3/3406; G09G 2320/0242; G09G 2320/0626; G09G 2330/021

(57) ABSTRACT

A display device and a method of adjusting backlight brightness of the display device are provided. The method includes converting original RGB signals of each pixel to corresponding RGBW signals; determining the color and original brightness value of each pixel based on the gray value ratio of the original RGB signals of each pixel; determining the backlight brightness value of each pixel based on the color of each pixel after the original RGB signals being converted; and performing weighted average calculation on the backlight brightness values of each pixel after the signals being converted, so as to obtain a whole backlight brightness adjustment value of all pixels.

This application claims priority to Chinese Patent Application No. 201510059648.0 filed on Feb. 4, 2015. The present application claims priority to and the benefit of the above-identified application and is incorporated herein in its entirety.

### TECHNICAL FIELD

Embodiments of the present invention relate to a display device and a method of adjusting backlight brightness of the display device.

### BACKGROUND

With the development of mobile communication technology, mobile phones have become very popular, and with the rapid development of mobile terminal technology and application, functions of the mobile phone have become increasingly rich, power consumption of the mobile phone is increased rapidly, and battery life of the mobile phone is correspondingly reduced. As an important portion of the mobile phone power consumption, the backlight power consumption is attracting more and more attention, and now dynamic backlight adjustment technology is the most frequently used technology for reducing backlight power consumption.

### SUMMARY

At least one embodiment of the present invention provides a method of adjusting backlight brightness of a display device, the method includes: converting original RGB signals of each pixel to corresponding RGBW signals; determining a color and original brightness value of each pixel based on a gray value ratio of the original RGB signals of each pixel; determining a backlight brightness value of each pixel based on the color of each pixel after the original RGB signals being converted; performing weighted average calculation on the backlight brightness values of all pixels after the signals being converted, so as to obtain the whole backlight brightness adjustment value of the pixels.

Embodiments of the present invention also provide a display device, the display device includes a signal decomposition unit, a backlight drive unit and a backlight control unit.

The signal decomposition unit is configured to convert original RGB signals of each pixel to corresponding RGBW signals;

The backlight drive unit is configured to determine a color and original brightness value of each pixel based on a gray value ratio of original RGB signals of each pixel, determine a backlight brightness value of each pixel based on the color of each pixel after the original RGB signals being converted; and perform weighted average calculation on the backlight brightness values of all pixels after the signals being converted, so as to obtain the whole backlight brightness adjustment value of the pixels.

The backlight control unit is configured to receive the whole backlight brightness adjustment value calculated by the backlight drive unit, and adjust the whole backlight brightness by controlling a duty ratio of pulse width modulation signal of a backlight source.

### BRIEF DESCRIPTION OF THE DRAWINGS

Embodiments of the present disclosure will be described in detail hereinafter in conjunction with accompanying drawings to allow one of ordinary skill in the art to understand the present disclosure more clearly, in which:

FIG. 1 is a flow diagram of a method of adjusting backlight brightness of a display device according to Embodiment 1;

FIG. 2 is a flow diagram of signal process in a part of units in a display device according to Embodiment 2.

### DETAILED DESCRIPTION

The technical solutions provided in the embodiments of the present invention will be described clearly and completely as below in conjunction with the accompanying drawings of embodiments of the present invention. It is apparent that the described embodiments are only a part of but not all of exemplary embodiments of the present invention. Based on the described embodiments of the present invention, various other embodiments and variants can be obtained by a person of ordinary skill in the art without creative labor and those embodiments and variants shall fall into the protection scope of the present invention.

Unless otherwise defined, all the technical and scientific terms used herein have the same meanings as commonly understood by one of ordinary skill in the art to which the present invention belongs. The terms, such as “first,” “second” or the like, which are used in the description and the claims of the present application, are not intended to indicate any sequence, amount or importance, but for distinguishing various components. Also, the terms, such as “a/an,” “one,” “the/said” or the like, are not intended to limit the amount, but for indicating the existence of at least one. The terms, such as “comprise/comprising,” “include/including” or the like, are intended to specify that the elements or the objects stated before these terms encompass the elements or the objects and equivalents thereof listed after these terms, but not preclude other elements or objects.

The inventor notice that a typical dynamic backlight adjustment technology directly outputs picture information to a display screen and adjusts backlight brightness, after gathering luminance and gray information statistics simply based on the content of a picture.

Although this adjustment method can reduce power consumption by properly changing the backlight brightness, since an approximate adjustment value is roughly given only based on the gray information statistical values of the picture, it cannot generate an accurate ratio as the reference value of backlight brightness adjustment, and it cannot clearly calculate the specific data of the duty ratio of pulse width modulation signal, which needs to be adjusted, of the backlight source based on the specific content of the picture, thus it cannot achieve the purpose of precise adjustment, and there are still a certain degree of backlight brightness waste.

Embodiments of the present invention provide a display device and a method of adjusting backlight brightness of the display device. The method gives a specific adjustment value for brightness of each pixel so that the backlight brightness is precisely adjusted, which overcomes the roughness of adjusting the backlight brightness in the prior art, further saving the backlight brightness.

### Embodiment 1

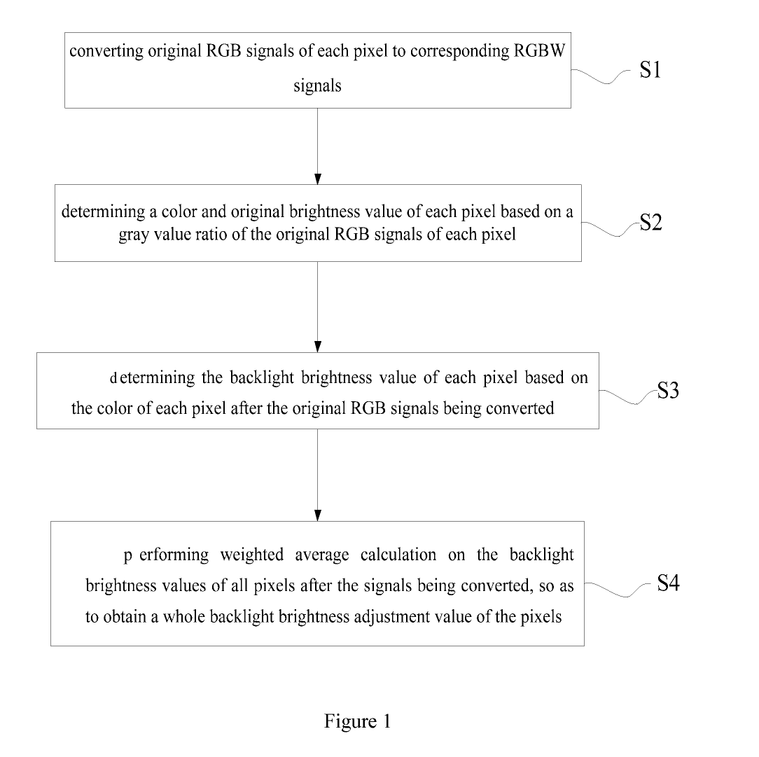

As shown in FIG. 1, the embodiment of the present invention provides a method of adjusting backlight brightness of the display device. The method includes: converting original RGB signals of each pixel to corresponding RGBW signals; determining the color and original brightness value of each pixel based on the gray value ratio of the original RGB signals of each pixel; determining the backlight brightness value of each pixel based on the color of each pixel after the original RGB signals being converted; performing weighted average calculation on the backlight brightness values of all pixels after the signals being converted, so as to obtain a whole backlight brightness adjustment value of the pixels.

The method of adjusting backlight brightness of the display device in the embodiment gives a specific adjustment value for brightness of each pixel so that the backlight brightness is precisely adjusted, which overcomes the roughness of adjusting the backlight brightness in the prior art, thereby further saving the backlight brightness.

For example, the method includes the following steps.

S1: the original RGB signals of each pixel are converted to the corresponding RGBW signals. The converting method can use various method in the art to perform conversion, which is not repeated herein.

S2: the color and original brightness value of each pixel are determined based on the gray value ratio of the original RGB signals of each pixel, which includes following situations.
if the gray value ratio of the RGB signals of a pixel is R:G:B=X:0:0, it is determined that a sub-pixel R in the pixel is lighted, the color of the pixel is pure red R; and the original brightness value of the pixel is calculated and stored;
if the gray value ratio of the RGB signals of a pixel is R:G:B=0:Y:0, it is determined that a sub-pixel G in the pixel is lighted, the color of the pixel is pure green G; and the original brightness value of the pixel is calculated and stored;
if the gray value ratio of the RGB signals of a pixel is R:G:B=0:0:Z, it is determined that a sub-pixel B in the pixel is lighted, the color of the pixel is pure blue B; and the original brightness value of the pixel is calculated and stored;
if the gray value ratio of the RGB signals of a pixel is R:G:B=0:Y:Z, it is determined that sub-pixels G and B in the pixel are lighted, the color of the pixel is cyan C; and the original brightness value of the pixel is calculated and stored;
if the gray value ratio of the RGB signals of a pixel is R:G:B=X:0:Z, it is determined that sub-pixels R and B in the pixel are lighted, the color of the pixel is magenta M; and the original brightness value of the pixel is calculated and stored;
if the gray value ratio of the RGB signals of a pixel is R:G:B=X:Y:0, it is determined that sub-pixels R and G in the pixel are lighted, the color of the pixel is yellow Y; and the original brightness value of the pixel is calculated and stored;
if the gray value ratio of the RGB signals of a pixel is R:G:B=255:255:255, it is determined that sub-pixels R, G and B in the pixel are lighted, the color of the pixel is white W; and the original brightness value of the pixel is calculated and stored;
if the gray value ratio of the RGB signals of a pixel is R:G:B=1:1:1 and each of gray values is less than 255, it is determined that sub-pixels R, G and B in the pixel are lighted, the color of the pixel is gray; and the original brightness value of the pixel is calculated and stored; and
if the gray value ratio of the RGB signals of a pixel does not fall into above situations, it is determined that sub-pixels R, G and B in the pixel are lighted, the color of the pixel is other color; and the original brightness value of the pixel is calculated and stored; where each of X, Y and Z is an integer which is greater than or equal to 1 and is less than or equal to 255.

The above situations determine the colors of pixels corresponding to RGB signals in the specific frame image information and determine the original brightness value of the pixel.

It should be understood that when the original RGB signals are converted to RGBW signals, the actual corresponding light-emitting area of pixel in the display panel is not changed, and only the number of sub-pixels is increased from 3 (R, G, B) to 4 (R, G, B, W).

It should be understood that the original RGB signals of a pixel can be calculated by using brightness algorithm to obtain the corresponding original brightness value of the pixel.

For example, the brightness algorithm can use the following formula:

Y=(2R+5G+B)/8, where Y represents brightness value, R,G,B respectively represent R,G,B gray value of original RGB signals.

It should be understood that it can use other brightness algorithms.

S3: the backlight brightness value of each pixel is determined based on the color of each pixel after the original RGB signals being converted.

The above nine situations can be divided into three types according to different colors.

For example, 1. The original brightness value of the pixel is increased by 1/12.

The original brightness values of pixels which are pure red R, pure green G and pure blue B are read, and the original brightness values are increased by 1/12 to act as the adjusted brightness values.

The pixel brightness is usually proportional to the light-emitting area of the pixel. For example, the backlight brightness is the same, and LCD deflection is the same.

After the original RGB signals are converted to RGBW signals, the light-emitting area of a single pixel is reduced from initial ⅓ to ¼, and the corresponding light-emitting brightness is also reduced by ⅓−¼= 1/12 compared to the backlight brightness of original RGB signals.

2. The original brightness value of pixel is increased by ⅙.

The original brightness values of pixels which are pure red R, pure green G and pure blue B are read, and the original brightness values are increased by 1/12 to act as the adjusted brightness values.

The pixel brightness is usually proportional to the light-emitting area of the pixel. For example, the backlight brightness is the same, and LCD deflection is the same.

After the original RGB signals are converted to RGBW signals, the light-emitting area of a single pixel is reduced from initial ⅔ to ½, and the corresponding light-emitting brightness is also reduced by ⅔−½=⅙ compared to the backlight brightness of original RGB signals. Therefore, the backlight brightness needs to be increased by ⅙.

3. The original brightness value of pixel is remained unchanged.

The original brightness values of pixels which are white W, gray and other color are read, and the original brightness values are remained unchanged to act as the adjusted brightness values.

After the original RGB signals are converted to RGBW signals, the light-emitting area of a single pixel is remained unchanged, that is all of the sub-pixels emit light. Therefore, the backlight brightness does not need to be adjusted.

Therefore, the brightness values of corresponding pixels in a given frame of an image are precisely adjusted.

S4: the whole backlight brightness adjustment values of all pixels are obtained by performing weighted average calculation on the backlight brightness values of the pixels resulted before and after the signals being converted.

In this way, all of pixels in the given frame of image have precise whole backlight brightness adjustment values. Therefore, the backlight brightness can be precisely adjusted by controlling the backlight source, for example, controlling the duty ratio pulse width modulation signal of the LED.

The adjustment of the backlight brightness is more precise, and can further save backlight brightness and reduce energy consumption, compared to statistical gray values of original RGB signals.

### Embodiment 2

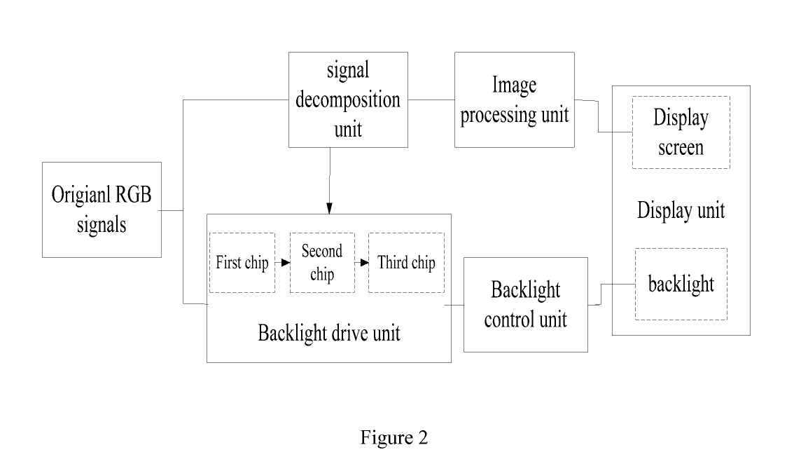

As shown in FIG. 2, the embodiment provides a display device. The display device includes a signal decomposition unit, a backlight drive unit and a backlight control unit.

The signal decomposition unit is configured to convert original RGB signals of each pixel to corresponding RGBW signals.

The video signal conversion method of each frame image can use various algorithms in the art.

A portion or component of the converted RGBW signals by the signal decomposition unit is transmitted to an image processing unit, and is processed by the image processing unit and transmitted to a display screen of a display unit to display the image. The processing method of the above image processing belongs to prior art, which is not repeated herein.

Another portion of the converted RGBW signal by the signal decomposition unit is transmitted to the backlight drive unit.

The backlight drive unit is configured to determine the color and original brightness value of each pixel based on the gray value ratio of original RGB signals of each pixel, determine the backlight brightness value of each pixel based on the color of each pixel after the original RGB signals being converted; and perform weighted average calculation on the backlight brightness values of all pixels to obtain a whole backlight brightness adjustment value of the pixels resulted before and after the signals being converted.

For example, the backlight drive unit includes a first chip, which is configured to determine and store the color of each pixel, and calculate and store original brightness value of each pixel based on the gray value ratio of original RGB signals of each pixel. It includes the following situations.
if the gray value ratio of the RGB signals of a pixel is R:G:B=X:0:0, it is determined that a sub-pixel R in the pixel is lighted, the color of the pixel is pure red R; and the original brightness value of the pixel is calculated and stored;
if the gray value ratio of the RGB signals of a pixel is R:G:B=0:Y:0, it is determined that a sub-pixel G in the pixel is lighted, the color of the pixel is pure green G; and the original brightness value of the pixel is calculated and stored;
if the gray value ratio of the RGB signals of a pixel is R:G:B=0:0:Z, it is determined that a sub-pixel B in the pixel is lighted, the color of the pixel is pure blue B; and the original brightness value of the pixel is calculated and stored;
if the gray value ratio of the RGB signals of a pixel is R:G:B=0:Y:Z, it is determined that sub-pixels G and B in the pixel are lighted, the color of the pixel is cyan C; and the original brightness value of the pixel is calculated and stored;
if the gray value ratio of the RGB signals of a pixel is R:G:B=X:0:Z, it is determined that sub-pixels R and B in the pixel are lighted, the color of the pixel is magenta M; and the original brightness value of the pixel is calculated and stored;
if the gray value ratio of the RGB signals of a pixel is R:G:B=X:Y:0, it is determined that sub-pixels R and G in the pixel are lighted, the color of the pixel is yellow Y; and the original brightness value of the pixel is calculated and stored;
if the gray value ratio of the RGB signals of a pixel is R:G:B=255:255:255, it is determined that sub-pixels R, G and B in the pixel are lighted, the color of the pixel is white W; and the original brightness value of the pixel is calculated and stored;
if the gray value ratio of the RGB signals of a pixel is R:G:B=1:1:1 and each of gray values is less than 255, it is determined that sub-pixels R, G and B in the pixel are lighted, the color of the pixel is gray; and the original brightness value of the pixel is calculated and stored; and
if the gray value ratio of the RGB signals of a pixel does not fall into above situations, it is determined that sub-pixels R, G and B in the pixel are lighted, the color of the pixel is other color; and the original brightness value of the pixel is calculated and stored; where each of X, Y and Z is an integer greater than or equal to 1 and is less than or equal to 255.

It should be understood that the original RGB signals of a pixel can be calculated by using brightness algorithm to obtain the corresponding original brightness value of the pixel. For example, the brightness algorithm can use the following formula:

Y=(2R+5G+B)/8, where Y represents brightness value, R,G,B respectively represent R,G,B gray value of original RGB signals.

The backlight drive unit can include a second chip, which is configured to read original brightness values of pixels which are pure red R, pure green G and pure blue B in the first chip, and increase the original brightness values by 1/12 to act as the adjusted brightness values; read original brightness values of pixels which are cyan C, magenta M and yellow Y, and increase the original brightness values by ⅙ to act as the adjusted brightness values; and read original brightness values of pixels which are white W, gray and other color, and remain the original brightness values unchanged to act as the adjusted brightness values.

The backlight drive unit can include a third chip, which is configured to read the backlight brightness values of each pixel in the second chip after the signals being converted, and perform weighted average calculation on the backlight brightness values of all pixels, so as to obtain a whole backlight brightness adjustment value of the pixels.

The backlight control unit is configured to receive the whole backlight brightness adjustment value calculated by the backlight drive unit, and adjust the whole backlight brightness by controlling the duty ratio of pulse width modulation signal of the backlight source.

It should be understood that the described above are only illustrative embodiments and implementations for explaining the principles of the present invention, and the present invention is not intended to be limited thereto. For one of ordinary skill in the art, various modifications and improvements may be made without departing from the spirit and scope of embodiments of the present invention, and all of which should fall within the protection scope of the present invention. The scope protected by the present invention is defined by the claims.

The present invention claims priority of Chinese patent application No. 201510059648.0 filed on Feb. 4, 2015 titled “a display device and a method of adjusting backlight brightness of the display device”, the whole contents of which are incorporated herein by reference.

What is claimed is:

1. A method of adjusting backlight brightness of a display device, comprising:
converting original RGB signals of each pixel to corresponding RGBW signals;
determining a color and original brightness value of each pixel based on a gray value ratio of the original RGB signals of each pixel;
determining the backlight brightness value of each pixel based on the color of each pixel after the original RGB signals being converted; and
performing weighted average calculation on the backlight brightness values of all pixels after the signals being converted, so as to obtain a whole backlight brightness adjustment value of the pixels.

2. The method of adjusting backlight brightness according to claim 1, wherein the determining of the color and original brightness value of each pixel based on the gray value ratio of the original RGB signals of each pixel comprises:
if the gray value ratio of the RGB signals of a pixel is R:G:B=X:0:0, it is determined that a sub-pixel R in the pixel is lighted, the color of the pixel is pure red R; and the original brightness value of the pixel is calculated and stored;
if the gray value ratio of the RGB signals of a pixel is R:G:B=0:Y:0, it is determined that a sub-pixel G in the pixel is lighted, the color of the pixel is pure green G; and the original brightness value of the pixel is calculated and stored;
if the gray value ratio of the RGB signals of a pixel is R:G:B=0:0:Z, it is determined that a sub-pixel B in the pixel is lighted, the color of the pixel is pure blue B; and the original brightness value of the pixel is calculated and stored;
if the gray value ratio of the RGB signals of a pixel is R:G:B=0:Y:Z, it is determined that sub-pixels G and B in the pixel are lighted, the color of the pixel is cyan C; and the original brightness value of the pixel is calculated and stored;
if the gray value ratio of the RGB signals of a pixel is R:G:B=X:0:Z, it is determined that sub-pixels R and B in the pixel are lighted, the color of the pixel is magenta M; and the original brightness value of the pixel is calculated and stored;
if the gray value ratio of the RGB signals of a pixel is R:G:B=X:Y:0, it is determined that sub-pixels R and G in the pixel are lighted, the color of the pixel is yellow Y; and the original brightness value of the pixel is calculated and stored;
if the gray value ratio of the RGB signals of a pixel is R:G:B=255:255:255, it is determined that sub-pixels R, G and B in the pixel are lighted, the color of the pixel is white W; and the original brightness value of the pixel is calculated and stored;
if the gray value ratio of the RGB signals of a pixel is R:G:B=1:1:1 and each of gray values is less than 255, it is determined that sub-pixels R, G and B in the pixel are lighted, the color of the pixel is gray; and the original brightness value of the pixel is calculated and stored; and
if the gray value ratio of the RGB signals of a pixel does not fall into above situations, it is determined that sub-pixels R, G and B in the pixel are lighted, the color of the pixel is other color; and the original brightness value of the pixel is calculated and stored;
where each of X, Y and Z is an integer greater than or equal to 1 and is less than or equal to 255.

3. The method of adjusting backlight brightness according to claim 1, further comprising: reading original brightness values of pixels which are pure red R, pure green G and pure blue B, and increasing the original brightness values by 1/12 to act as the adjusted brightness values.

4. The method of adjusting backlight brightness according to claim 1, further comprising: reading original brightness values of pixels which are cyan C, magenta M and yellow Y, and increasing the original brightness values by ⅙ to act as the adjusted brightness values.

5. The method of adjusting backlight brightness according to claim 1, further comprising: reading original brightness values of pixels which are white W, gray and other color, and remaining the original brightness values unchanged to act as the adjusted brightness values.

6. A display device, comprising:
signal decomposition unit configured to convert original RGB signals of each pixel to corresponding RGBW signals;
a backlight drive unit configured to determine a color and original brightness value of each pixel based on a gray value ratio of the original RGB signals of each pixel, determine a backlight brightness value of each pixel based on the color of each pixel after the original RGB signals being converted; and perform weighted average calculation on the backlight brightness values of all pixels after the signals being converted, so as to obtain a whole backlight brightness adjustment value of the pixels; and
a backlight control unit configured to receive the whole backlight brightness adjustment value calculated by the backlight drive unit, and adjust the whole backlight brightness by controlling a duty ratio of pulse width modulation signal of a backlight source.

7. The display device according to claim 6, wherein the backlight drive unit comprises a first chip, which is configured to determine and store the color of each pixel, and calculate and store and original brightness value of each pixel based on the gray value ratio of the original RGB signals of each pixel, comprising the following situations:
if the gray value ratio of the RGB signals of a pixel is R:G:B=X:0:0, it is determined that a sub-pixel R in the pixel is lighted, the color of the pixel is pure red R; and the original brightness value of the pixel is calculated and stored;
if the gray value ratio of the RGB signals of a pixel is R:G:B=0:Y:0, it is determined that a sub-pixel G in the pixel is lighted, the color of the pixel is pure green G; and the original brightness value of the pixel is calculated and stored;
if the gray value ratio of the RGB signals of a pixel is R:G:B=0:0:Z, it is determined that a sub-pixel B in the pixel is lighted, the color of the pixel is pure blue B; and the original brightness value of the pixel is calculated and stored;
if the gray value ratio of the RGB signals of a pixel is R:G:B=0:Y:Z, it is determined that sub-pixels G and B in the pixel are lighted, the color of the pixel is cyan C; and the original brightness value of the pixel is calculated and stored;
if the gray value ratio of the RGB signals of a pixel is R:G:B=X:0:Z, it is determined that sub-pixels R and B in the pixel are lighted, the color of the pixel is magenta M; and the original brightness value of the pixel is calculated and stored;
if the gray value ratio of the RGB signals of a pixel is R:G:B=X:Y:0, it is determined that sub-pixels R and G in the pixel are lighted, the color of the pixel is yellow Y; and the original brightness value of the pixel is calculated and stored;
if the gray value ratio of the RGB signals of a pixel is R:G:B=255:255:255, it is determined that sub-pixels R, G and B in the pixel are lighted, the color of the pixel is white W; and the original brightness value of the pixel is calculated and stored;
if the gray value ratio of the RGB signals of a pixel is R:G:B=1:1:1 and each of gray values is less than 255, it is determined that sub-pixels R, G and B in the pixel are lighted, the color of the pixel is gray; and the original brightness value of the pixel is calculated and stored; and
if the gray value ratio of the RGB signals of a pixel does not fall into above situations, it is determined that sub-pixels R, G and B in the pixel are lighted, the color of the pixel is other color; and the original brightness value of the pixel is calculated and stored;
where each of X, Y and Z is an integer greater than or equal to 1 and is less than or equal to 255.

8. The display device according to claim 6, wherein the backlight drive unit further comprises a second chip, which is configured to:
read original brightness values of pixels which are pure red R, pure green G and pure blue B in the first chip, and increase the original brightness values by 1/12 to act as the adjusted brightness values;
read original brightness values of pixels which are cyan C, magenta M and yellow Y, and increase the original brightness values by ⅙ to act as the adjusted brightness values; and
read original brightness values of pixels which are white W, gray and other color, and remain the original brightness values unchanged to act as the adjusted brightness values.

9. The display device according to claim 6, the backlight drive unit further comprises a third chip, which is configured to read the backlight brightness values of each pixel in the second chip after the signals being converted, and perform weighted average calculation on the backlight brightness values of all pixels, so as to obtain the whole backlight brightness adjustment value of the pixels.

10. The method of adjusting backlight brightness according to claim 2, further comprising: reading original brightness values of pixels which are pure red R, pure green G and pure blue B, and increasing the original brightness values by 1/12 to act as the adjusted brightness values.

11. The method of adjusting backlight brightness according to claim 2, further comprising: reading original brightness values of pixels which are cyan C, magenta M and yellow Y, and increasing the original brightness values by ⅙ to act as the adjusted brightness values.

12. The method of adjusting backlight brightness according to claim 3, further comprising: reading original brightness values of pixels which are cyan C, magenta M and yellow Y, and increasing the original brightness values by ⅙ to act as the adjusted brightness values.

13. The method of adjusting backlight brightness according to claim 10, further comprising: reading original brightness values of pixels which are cyan C, magenta M and yellow Y, and increasing the original brightness values by ⅙ to act as the adjusted brightness values.

14. The method of adjusting backlight brightness according to claim 2, further comprising: reading original brightness values of pixels which are white W, gray and other color, and remaining the original brightness values unchanged to act as the adjusted brightness values.

15. The method of adjusting backlight brightness according to claim 3, further comprising: reading original brightness values of pixels which are white W, gray and other color, and remaining the original brightness values unchanged to act as the adjusted brightness values.

16. The method of adjusting backlight brightness according to claim 4, further comprising: reading original brightness values of pixels which are white W, gray and other color, and remaining the original brightness values unchanged to act as the adjusted brightness values.

17. The method of adjusting backlight brightness according to claim 13, further comprising: reading original brightness values of pixels which are white W, gray and other color, and remaining the original brightness values unchanged to act as the adjusted brightness values.

18. The display device according to claim 7, wherein the backlight drive unit further comprises a second chip, which is configured to:
read original brightness values of pixels which are pure red R, pure green G and pure blue B in the first chip, and increase the original brightness values by 1/12 to act as the adjusted brightness values;
read original brightness values of pixels which are cyan C, magenta M and yellow Y, and increase the original brightness values by ⅙ to act as the adjusted brightness values; and
read original brightness values of pixels which are white W, gray and other color, and remain the original brightness values unchanged to act as the adjusted brightness values.

19. The display device according to claim 7, the backlight drive unit further comprises a third chip, which is configured to read the backlight brightness values of each pixel in the second chip after the signals being converted, and perform weighted average calculation on the backlight brightness values of all pixels, so as to obtain the whole backlight brightness adjustment value of the pixels.

20. The display device according to claim 8, the backlight drive unit further comprises a third chip, which is configured to read the backlight brightness values of each pixel in the second chip after the signals being converted, and perform weighted average calculation on the backlight brightness values of all pixels, so as to obtain the whole backlight brightness adjustment value of the pixels.
